(19) United States
(12) Patent Application Publication
(10) Pub. No.: US 2012/0297429 A1
(43) Pub. Date: Nov. 22, 2012

(54) Emulating Television Viewing Experience In A Browser

(75) Inventors: William Edward Reed, Bainbridge Island, WA (US); William Ryan Massie, San Francisco, CA (US); Elizabeth D. Carrasco, Palo Alto, CA (US); Holl Yu Liou, San Francisco, CA (US)

(73) Assignee: CBS Interactive, Inc., San Francisco, CA (US)

(21) Appl. No.: 13/109,935

(22) Filed: May 17, 2011

(51) Int. Cl. H04N 7/173

(52) U.S. Cl. 725/86; 725/117

(57) ABSTRACT

Video content delivery method is provided for operating in a network environment to display online content, including television content on a media device through a Web browser having an application program interface (API), at least in part to emulate a television viewing experience. Online content is received at a server from content source(s) and delivered to users in response to receiving a content request at the server. Requested online content is transmitted to the Web browser, instructions are provided to store the online content in the API of the Web browser. Online content is rendered from the API to the Web browser graphical user interface (GUI) and the online content is asynchronously updated between the server and the Web browser while rendering of the online content, at least in part to emulate a television viewing experience. Instructions are provided for storing the state information from the GUI to the API.

### FIELD OF THE TECHNOLOGY

The technology is generally directed to control of media content. More particularly, the technology is directed to emulating the television viewing experience in a web browser for media content.

### BACKGROUND OF THE TECHNOLOGY

Conventional technologies for emulating the television viewing experience for online con tent include proprietary software applications and proprietary hardware devices configured to display online content. For example, the proprietary software may include non-browser applications that are stored on client-side media devices. The proprietary software may be configured to mimic TV channels or a TV guide experience using existing hardware devices, such as computer devices. These computer devices may include minimum hardware configurations for running the proprietary software applications.

Alternatively, proprietary hardware devices, such as set top boxes, may be provided to operate in conjunction with existing viewing devices, such as televisions. The proprietary hardware devices may include minimum hardware configurations for running the proprietary software applications. Conventional approaches for displaying and interacting with online content may require users to obtain proprietary software devices and proprietary hardware devices that interface with existing viewing devices.

### BRIEF DESCRIPTION OF THE DRAWINGS

The drawings appended hereto are intended to illustrate contemplated embodiments of the technology. The drawings are not intended to limit the technology solely to the embodiments illustrated and described.

FIG. 1A illustrates a process diagram for performing asynchronous operation and state preservation according to one embodiment of the technology;

FIG. 1B illustrates a system diagram according to one embodiment of the technology;

FIG. 2 illustrates a screenshot of a home page user interface according to one embodiment of the technology;

FIG. 3 illustrates a screenshot of a episode user interface according to one embodiment of the technology;

FIG. 4 illustrates a screenshot of a search result user interface according to one embodiment of the technology;

FIG. 5 illustrates a process diagram for presenting search results according to one embodiment of the technology; and

FIG. 6 illustrates a process diagram for determining input context according to one embodiment of the technology.

### DETAILED DESCRIPTION OF THE TECHNOLOGY

While specific embodiments of the technology are discussed herein and are illustrated in the drawings appended hereto, the technology encompasses a broader spectrum than the specific subject matter described and illustrated. As would be appreciated by those skilled in the art, the embodiments described herein provide but a few examples of the broad scope of the technology. There is no intention to limit the scope of the technology only to the embodiments described herein.

Widespread deployment of computer networks enable dissemination of enormous amounts of content that originates from various sources, including online content providers, among other sources. While Web browsers offer seemingly unlimited access to online content, traditional computer devices are generally not configured for passive television or video viewing. For example, Web browsers typically display content links that are navigated using a two dimensional navigation device, such as a mouse. Furthermore, average computer screens are dimensioned smaller than average television screens. In other words, conventional Web browsers offer a different user experience for navigation and viewing content compared to traditional television devices. Improvements that offer utility to address the problems of existing approaches, e.g., special purpose hardware, proprietary software, include employing industry-compliant Web browser applications that receive online content from various sources and emulate traditional television viewing experiences, including remote control content navigation using the graphical user interface

The technology can use industry-compliant Web browsers, such as HyperText Markup Language (HTML) Web browsers, to create Web browser applications that are stored within the client-side media devices, including televisions and computers. The Web browser applications can be configured to normalize, index, display and enable interactions with online content, including movie content, Web content, television content, and live content, among other online content.

The technology can employ HTML5 functionality and Asynchronous JavaScript And eXtensible Markup Language (AJAX) to provide the Web browser applications. AJAX enables asynchronous operation between (1) the Web browser and the user and (2) the Web browser and servers in order to display content at render speeds that compare to render speeds of desktop applications. To this end, AJAX provides an AJAX engine within the Web browser that stores data for responding to user data requests. In other words, AJAX performs data transmission between the Web browser and the servers while simultaneously updating the graphical user interface to display content obtained from the AJAX engine. This enables the Web browser application to load portions of a Web page content rather than loading all content on the Web page.

The technology can use JavaScript and Document Object Model (DOM) to store data on the client device and provide Web browser application functionality. The JavaScript may be loaded with the Web page to handle basic tasks, including data validation, data manipulation and display rendering. The AJAX engine handles these tasks without performing server requests. By contrast, standard Web browsers suffer performance delays when data requests are sent to the servers and the Web browser waits for a response prior to updating content on the graphical user interface.

The technology further can include an object store application program interface (API) that coordinates local object storing to satisfy off-line data requirements of the Web browser applications, including the AJAX engine storage requirements. The object store API can be associated with a database of records that hold simple values and hierarchical objects. The database can maintain indexes over records to enable the object store API to locate desired records. A query language can be layered on the object store API.

The technology can employ search engines and other tools to crawl the World Wide Web and obtain voluminous search results. The search results can be retrieved in a random order and can be indexed so that consumers may enter queries into search engines to locate desired content. The various types of online content can be associated with searchable data, such as tags or other searchable data. The searchable data can be analyzed by search engines to render search result hits. The online content also can be associated with sources that disseminate the online content. In this case, the technology can display a plurality of source identifiers associated with substantially similar online content, among providing other information. Users may locate and select online content based on the content source identifiers, among other selection criteria.

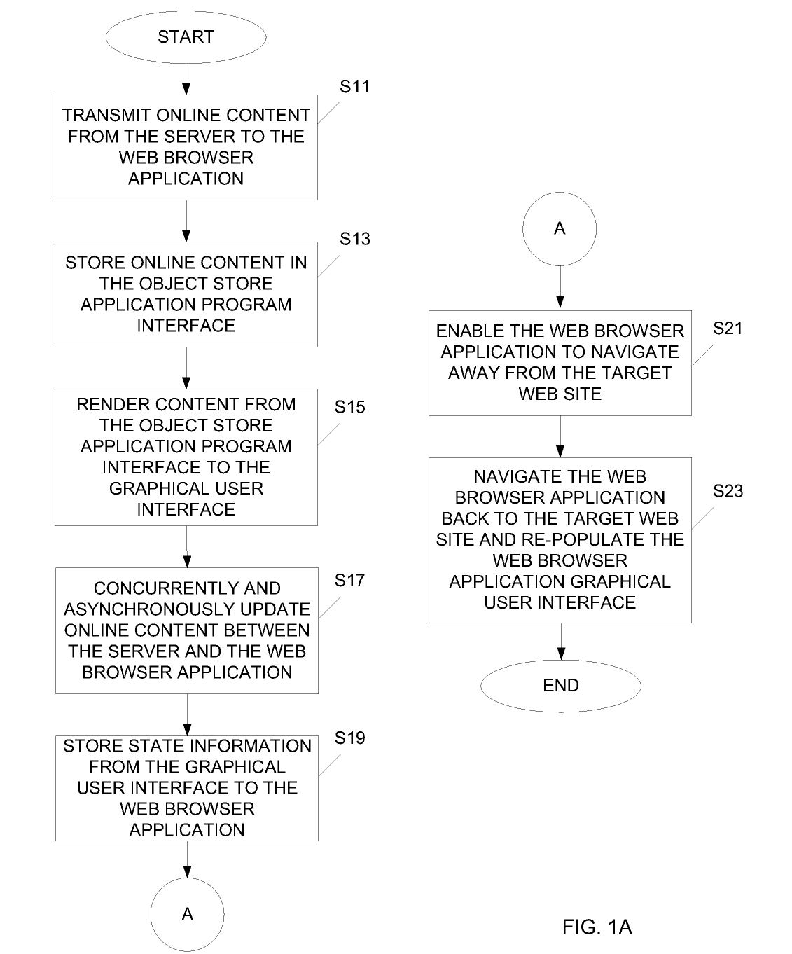

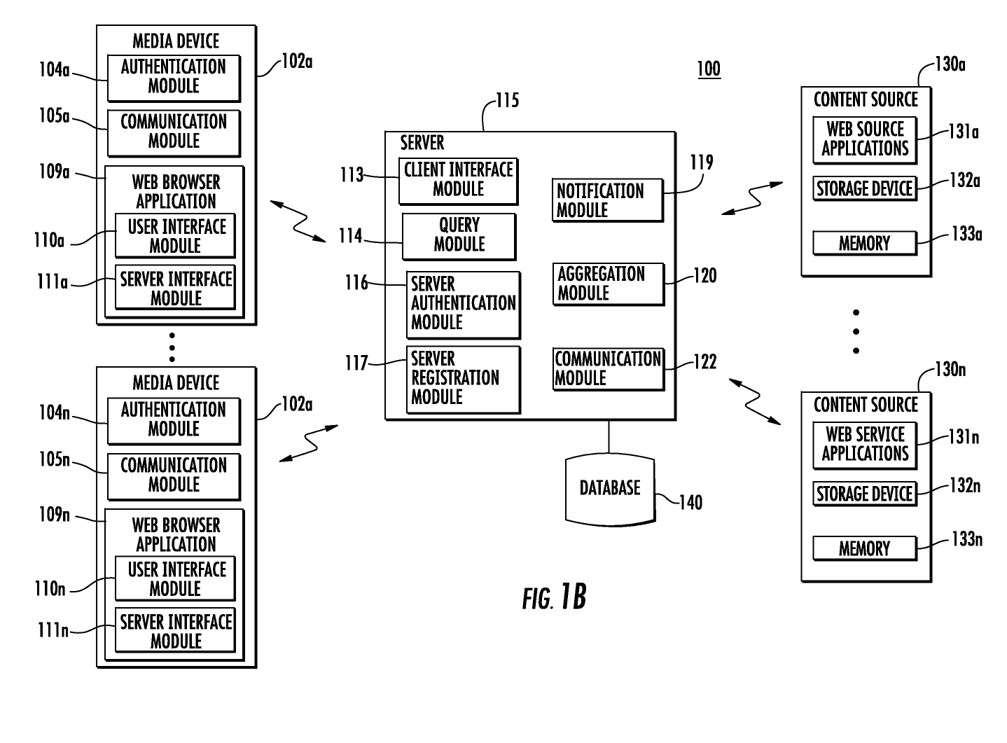

FIG. 1A is a process diagram 10 for performing asynchronous operation and state preservation according to embodiments of the technology. In step S11, Web browser application data of the present technology can be transmitted between the server and the Web browser application 109. In step S13, the transmitted data can stored in the object store via the application programming interface (API) of the technology. In step S15, the transmitted data can be rendered from the object store via the API to the user interface of the Web browser application 109. In step S17, the online content can be updated between the server and the Web browser application 109 concurrently and asynchronously. In step S19, state information of the Web browser application 109 is stored from the user interface to the client side object store. In step S21, the Web browser is navigated away from a Web browser application page. In step S23, the Web browser is returned to the Web browser application page using the state information from the client side object store. While the steps are shown as serial for simplicity of explanation, several steps, e.g., the concurrent update of Web browser application data from the server and interaction with the user through the user interface, can be performed in parallel.

The technology provides systems, methods, and computer program products for discovering and cataloging Internet content disseminated using the World Wide Web, among other information protocols. The technology further can provide normalizing, indexing, displaying and searching the cataloged online content based on pre-selected criteria, such as categories, properties and metrics, among other pre-selected criteria. To this end, the technology can include a search engine, a directory generator, a wiki generator, an entertainment guide generator and a digital video recorder, among other components.

FIG. 1B illustrates system architecture 100 according to one embodiment of the technology. Media devices 102a-102n (hereinafter media devices 102), one or more servers 115, and remote content sources 130a-130n (hereinafter content sources 130) can be connected via wired media, wireless media, or a combination of the foregoing. According to one embodiment, the media devices 102, the servers 115, and the remote content sources 130 can reside in one or more networks, such as an Internet, an intranet, or a combination thereof.

The media devices 102 can include types of media devices, including televisions, tablet computers, laptop computers, personal computers, smart telephones, cellular telephones, set-top boxes, video-playing devices, video disc players, such as DVD and Blu-ray players, and portable media devices that combine the functionality of one or more of the foregoing or other media devices. The media devices 102 can include several components, such as processors, RAM, USB interfaces, telephone interfaces, microphones, speakers, a navigation device, a wide area network interface, local area network interfaces, hard disk drives, wireless communication interfaces, a keyboard, a touch-screen display, a computer display, and/or other components. The media devices 102 can include, or be modified to include, software and hardware components that provide content gathering and content exchange functionality.

The media devices 102, the servers 115, and/or the content sources 130 can include several modules. The modular construction facilitates adding, deleting, updating and/or amending modules therein and/or features within modules. The media devices 102 may include an authentication module 104, a communications module 105, and a Web browser application 109, among other modules. The servers 115 can include a client interface module 113, a query module 114, a server authentication module 116, a server registration module 117, a notification module 119, an aggregation module 120, and a server communication module 122, among other modules. It should be readily understood that a greater or lesser number of modules can be used. One skilled in the art will readily appreciate that the technology can be implemented using individual modules, a single module that incorporates the features of two or more separately described modules, individual software programs, and/or a single software program.

The media devices 102 can communicate over the Internet using a Web browser. For example, the media devices 102 may employ a Web operating system to operate at the Web level, rather than operating at the individual application level. Therefore, content associated with applications running on a Web browser can freely be shared among applications running through the Web browser on the media devices 102. For example, users may employ a mapping application within the Web browser to generate map content. The map content may be dragged into a body portion of a separate email application, which also runs on the Web browser. The Web browser can use, for example, java scripts supported by a JavaScript library and a server having a public application program interface (API) to enable content sharing. The Web operating system can enable the media device 102 and the server 115 to add and remove applications on the fly. The technology can enable users to view online media program content from within a single Web browser application 109. In other words, users interact with the user interface using a single, seamless application in the Web Browser. The technology can use AJAX to support dynamic content pulling to Web pages and further enhances browser application performance by using the asynchronous operations and the object store, via an API, to reduce latency. The enhanced data retrieval rates effectively transform the Web browser to an application that runs locally on the client device.

The system 100 supports Web-based services that host applications in a network computing environment. The servers 115 can host various applications and can coordinate data communication between the media devices 102, the content sources 130 and the databases 140, among other devices. The media devices 102 can be thin client devices that leverage computing power from the servers 115. In other words, the media devices 102 can use interface software, such as Web browsers, to access information from the network computing devices, including the servers 115, the content sources 130 and the databases 140, among other server-based computing devices.

The system 100 enables on-line content providers to offer on-demand content models instead of traditional linear television (TV) models. The on-demand content models provide viewers with flexibility to control content options, including content selection; content viewing location; content delivery options, including playing content, pausing content and stopping content; and selecting content resolution, among providing other content delivery options. By contrast, traditional linear TV models offer viewers scheduled TV programs at a particular time and on a particular channel. The traditional linear TV models may vary advertising for selected geographical regions, but otherwise offer uniform content on a large scale, such as a national scale.

Content selection for the on-demand content models can generally be controlled at the servers 115 located within the network computing environment. By contrast, content selection for traditional linear television (TV) models is generally controlled at set-top boxes connected to the television. Since content selection is controlled at the servers 115 for the on-demand content model, users may select or filter content using the interface software or browser provided at the media devices 102. As a result, Web-based content providers may offer individualized programming on the order of several thousand different broadcast versions.

Content delivery can be adjusted or controlled based on media devices capabilities. Additionally, Web-based content providers may control content delivery based on selected criteria, including geography or other selected criteria. In other words, during time sensitive programming, such as live sporting events, Web-based content providers may restrict content delivery to selected geographic regions. Content restriction can be performed through mapping of Internet Protocol (IP) addresses, among other techniques.

The Web operating system enables the media device 102 and the server 115 to manage multiple users, including storing customized settings for each user; dynamically negotiating system resources; supervising applications to ensure lightweight operation; preventing data collisions; preventing software and hardware conflicts; granting access to the Web-based services via the Internet from anywhere and at any time; performing software updates to central Web applications that are accessed corporate-wide; and ensuring that software and hardware are compatible; among providing other functionality.

The client interface module 113 can support several user interface devices including display screens, voice recognition systems, speakers, microphones, and input buttons, among other user interface devices. The client interface modules 113 can communicate with the Web browser application 109 associated with the media device 102. Features on the user interface devices can be selected through the media devices 102. For example, features can be selected by navigating a cursor over desired icons using an input device, such as a remote control, a mouse, or a keyboard, among other input devices. Alternatively, functions can be performed on the media device 102 using voice recognition systems that enable hands-free operation. Still further, functions can be performed on the media device 102 using a touch-sensitive display screen, among other user interface techniques.

The media devices 102 can include communication modules 105a-105n (hereinafter communication modules 105) for enabling the media devices 102 to communicate with systems to exchange data. The communication systems can include other media devices 102, the servers 115, the content sources 130, the database 140 and/or other systems. The media devices 102 can communicate via communications media such as, for example, any wired and/or wireless media. According to one embodiment, communications between the media devices 102, the content sources 130, the database 140 and the servers 115 can occur substantially in real-time when the devices are coupled to the network

Alternatively, communications can be delayed for an amount of time if, for example, one or more media devices 102, the servers 115, the database 140 and/or the content sources 130 are not coupled to the network. Requests that are submitted while the media devices 102 or the content sources 130 are not coupled to the network can be stored and propagated from/to the offline media devices 102 or the content sources 130 when the target media devices 102 or the target content sources 130 are re-coupled to the network. One of ordinary skill in the art will appreciate that communications can be conducted in various ways and among various devices.

The servers 115 can include a query module 114 that communicates with the Web browser application 109 on the media devices 102 to enable users to formulate search queries for searching the databases 140 or other data structures on the server-side. The databases 140 can be searched using any variety of techniques. For example, a database search can be performed using a structured query language (SQL) that uses SQL statements to perform tasks on the databases 140. The tasks can include searching database entries associated with the online content, including database entries associated with movie content, Web content, television content, and live content, among other online video content.

The media devices 102 include the Web browser application 109 having a user interface module 111a and a server interface module 111a to obtain and display content received from the server 115, the databases 140 and/or the content sources 130 (either directly or through the server 115). The Web browser application 109 can display in real-time the content received from the servers 115, the databases 140 and/or the content sources 130. Alternatively, the Web browser application 109 may include an API that caches the content received from the servers 115, the database 140 and/or the content sources 130 for display at a later time. According to some embodiments, only particular media devices 102 can be authorized to receive particular content, such as content from subscription based sources. The authentication modules 104a-104n (hereinafter authentication modules 104) can be provided to perform gatekeeper services for any restricted content.

The content sources 130 may include any number of different types of content sources, including servers, personal computers, tablet computers, laptop computers, smart phones, digital cameras, digital music players or other content sources. The content sources 130 may generate and store digital content. Alternatively, the content sources 130 may simply store digital content for retrieval. The content sources 130 may include several components, including processors, RAM, a USB interface, a telephone interface, microphones, speakers, navigation devices, a computer mouse, a wide area network interface, local area network interfaces, hard disk drives, wireless communication interfaces, a keyboard, a touch-screen display and/or other components.

The content sources 130 may include, or be modified to include, Web service applications 131a-131n (hereinafter Web service applications 131), storage devices 132a-132n (hereinafter storage devices 132) and a memory 133a-133n (hereinafter memory 133). The Web service applications 131 may operate to gather and exchange data, among performing other operations. The technology may enable data communication tracking across the network. For example, the Web service applications 131 may associate an internet protocol (IP) address, or other identifying information, of the content sources 130 with data that is provided by the content sources 130. The data tracking features may generate data usage logs. For example, the Web service applications 131 may provide data that identifies requester information, content source information, data obtained from the content sources 130 and royalty information associated with retrieved data, among other identifying data. The identifying data may be provided in real-time. Alternatively, the identifying data may be provided after a time delay.

The servers 115 can coordinate communications with the content sources 130. For example, the servers 115 can control the content sources 130 to send data packets across the network between the servers 115 and the content sources 130. The data packets can include identification markers that facilitate content tracking The servers 115 can scan the received data packets for the predetermined identification markers and can capture data packets having the predetermined identification markers. The servers 115 can coordinate forwarding the received content between the media devices 102 and the storage devices 132. The media devices 102 can locally store content and/or other data, such as Web browser application data retrieved from the database 140.

The servers 115 can include an aggregation module 120 that aggregates content received from the various content sources 130. The aggregation module 120 can operate according to rules that define how the content may be aggregated. For example, the content can be aggregated based on categories, including content source information, content-type information and content creation date information, among other categories.

The technology can enable users to create an individual account with a corresponding profile to customize the user experience. To this end, the servers 115 can include a server registration module 117 to register new users. If, at login, the media devices 102 are operating online and a determination is made that the user has not previously registered, then the user can be provided with a registration user interface via the media device 102. Requested registration information can include a first name, a last name, an email address, a user name and a password, among other registration information. Following receipt of the registration information and after performing a verification process, the server registration module 117 can add the user to a list of authorized users.

Once registered, the media devices 102 can be used to subsequently authenticate users prior to granting access to the user accounts. The authentication modules 104 can employ one of several different authentication schemes, as would be appreciated by those skilled in the art. The authentication modules 104 can prompt users to enter a username and password, among other identifying information. Alternatively, the user authentication modules 104 can prompt users to provide biometric information (i.e., a thumbprint through a fingerprint scanner) or other suitable identifying information. If the user is not identified, then the user can be invited to resubmit the requested identification information or to take other action.

A server authentication module 116 can be associated with the servers 115 to receive authentication information entered into the corresponding media device 102 via the authentication modules 104. The server authentication module 116 can compare the identifying information against existing records and operate as a gatekeeper to the system 100. If the user is determined to be a registered user, the authentication module 116 can attempt to authenticate the registered user by matching the entered authentication information with access information that exists on the servers 115. If the user is not authenticated, then the user can be invited to resubmit the requested identifying information or take other action. If the user is authenticated, then the servers 115 can perform other processing. For example, the media devices 102 can receive information from the servers 115 and/or from another authenticated media device 102.

The servers 115 can include a notification module 119 that generates notifications and/or alerts as defined in a user's individual account or profile. The notification module 119 can generate and forward notification messages to media devices 102 and/or to the content sources 130 upon receipt of information by the servers 115. For example, the notifications can include reports of items, such as availability of requested content, a content list recently retrieved from content sources 130 and generation of a content list by selected friends, among other items. The notification module 119 can generate notifications that are communicated to the media device 102, such as via electronic mail, mobile telephones, telephone messages, text messages, instant messages, and other communication technique.

According to some embodiments, a minimal amount of content retrieved from the content sources 130 can be stored at the servers 115 and the media devices 102. In other words, the servers 115 can perform content gathering functions and can thereafter maintain links to the discovered content. Alternatively, the retrieved content can be stored at the servers 115 and/or the media devices 102 for a predetermined amount of time before being purged.

The servers 115 can include a server communications module 122 that enables the servers 115 to communicate with systems, including other media devices 102, other servers 115, and the content sources 130, among other systems. The servers 115 can communicate via communications media such as, for example, any wired and/or wireless media. Communications between the media devices 102, the content sources 130 and the servers 115 can occur substantially in real-time, when the devices are coupled to the network. The server communications module 122 communicates with the media devices 102 to exchange content or data, among performing other functions.

Communications may be delayed for an amount of time if, for example, the target media devices 102, the server 115, and/or the content sources 130 are not coupled to the network. Furthermore, any requests that are submitted while the media devices 102 and/or the content sources 130 are not coupled to the network can be stored and propagated from/to the offline media devices 102 and/or the content sources 130 when the target media devices 102 and/or the content sources 130 are re-coupled to the network. One of ordinary skill in the art will appreciate that communications can be conducted in various ways and among various devices.

FIGS. 1A and 1B are provided for illustrative purposes only and should not be considered to limit the claimed embodiments of the technology. Other configurations will be appreciated by those skilled in the art and are intended to be encompassed by the technology.

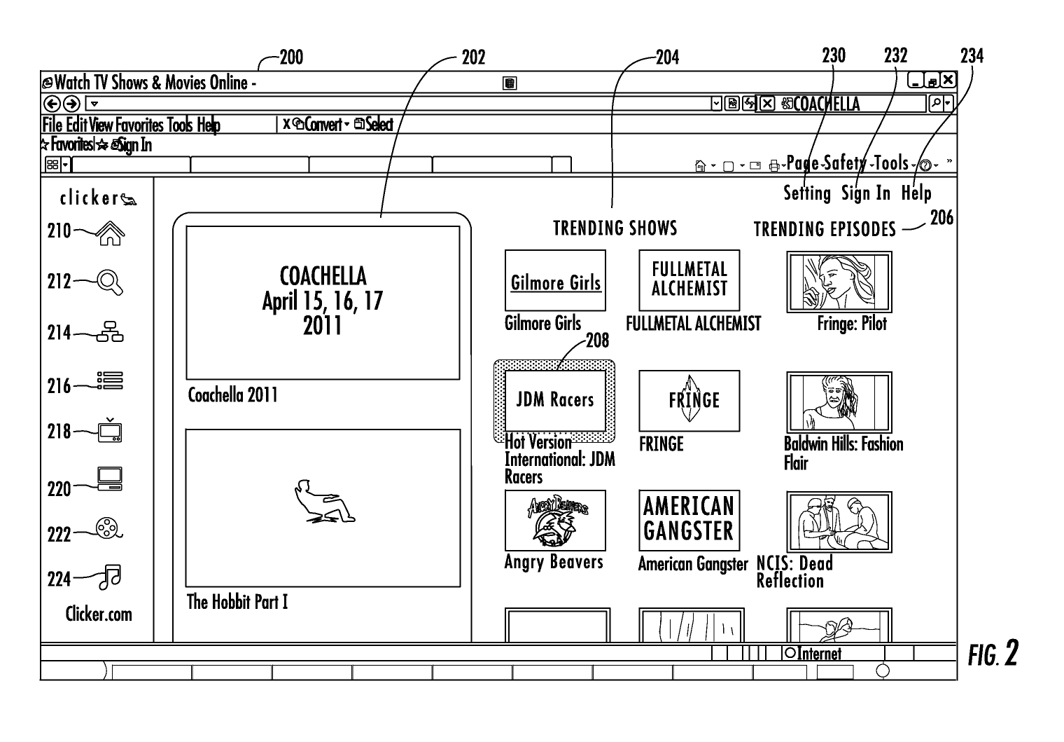

FIG. 2 illustrates an exemplary screen-shot of a home page user interface (UI) 200 that can be displayed on the corresponding media device 102. Upon launching the client interface module 113, the home page UI 200 can be presented to the user. Various user interfaces are described below that provide primary mechanisms for interaction between the user and the media devices 102.

The home page UI 200 provides a layout of components with which the user may interact through the Web browser application 109 using, for example, arrow keys on a keyboard or on a remote control. For example, the home page UI 200 can present feature content 202 that is relevant to a selected date (i.e., today's date) and other content categories, such as a trending shows category section 204 and a trending episodes category section 206. The trending shows category section 204 and the trending episodes category section 206 can include image content and titles describing the corresponding image content. The image content may include movie content, Web content, television content, music content and live content, among other online content. The home page UI 200 may include a plurality of high-level icons such as, for example, a home icon 210, a search icon 212, a categories icon 214, a queue icon 216, a TV icon 218, a Web icon 220, a movies icon 222 and a music icon 224, among other icons. The home page UI 200 further can include a settings selector 230, a Sign In selector 232 and a Help selector 234.

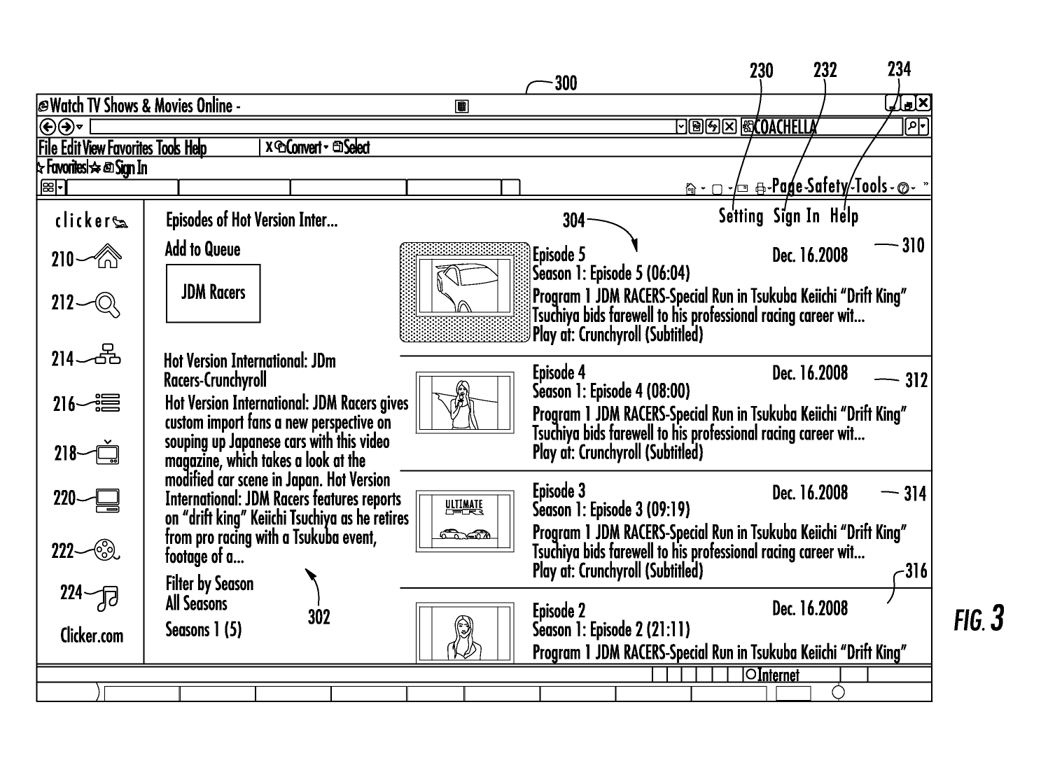

FIG. 3 illustrates an exemplary screen-shot of an episode user interface (UI) 300 that can be presented on the media devices 102 upon selection of a particular icon. In this case, selection details are illustrated for the JDM Racers icon 208 of FIG. 2. The episode UI 300 can provide a wiki-style description 302 of the JDM Racers icon 208, along with a related episodes section 304 that can present a plurality of related content icons for selection. The plurality of content icons include an episode 5, season 1 icon 310; an episode 4, season 1 icon 312; an episode 3, season 1 icon 314; and an episode 2, season 1 icon 316. Each of content icons 310-316 includes at least a description of the episode and an identification of the content sources where the episode may be stored.

Upon selecting a desired content icon 310-316, the Web browser application 109 is directed to the corresponding content source 130 to enable users to view content associated with the selected content icon 310-316. The episode UI 300 may include a plurality of high-level icons such as, for example, the home icon 210, the search icon 212, the categories icon 214, the queue icon 216, the TV icon 218, the Web icon 220, the movies icon 222 and the music icon 224, among other icons. The episode UI 300 further may include the settings selector 230, the Sign In selector 232 and the Help selector 234.

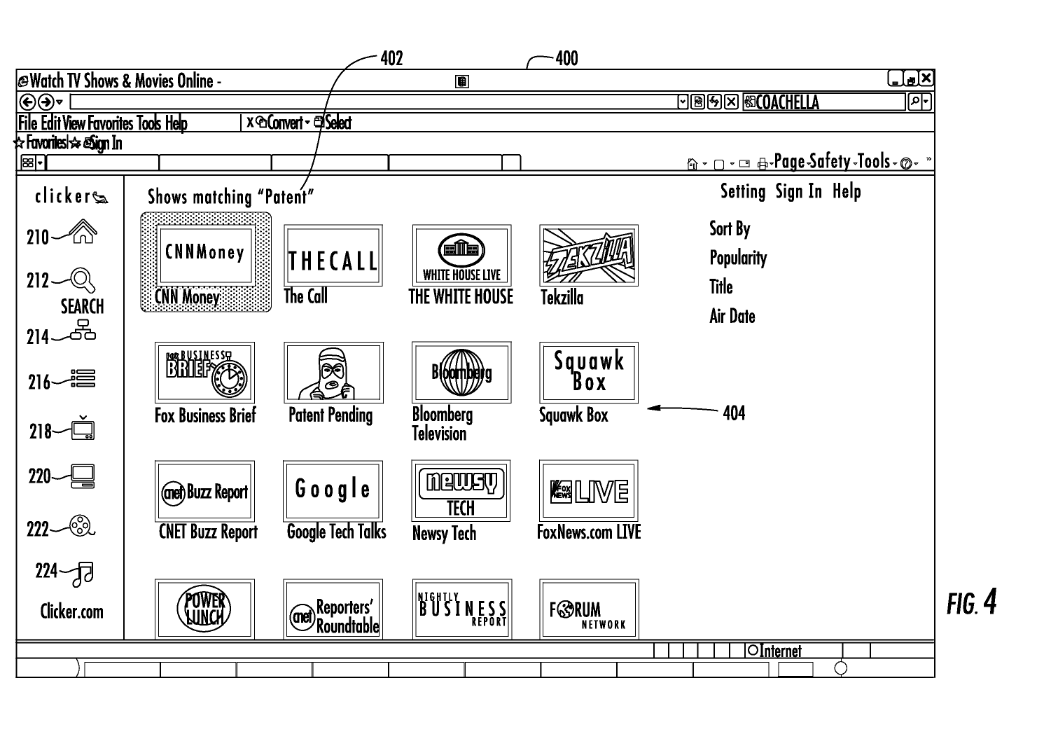

FIG. 4 illustrates an exemplary screen-shot of a search result user interface (UI) 400 that can be presented upon typing a search term within the Web browser application 109. FIG. 4 illustrates search results for the search query “patent” 402. The technology enables users to enter the search query 402 within any Web page associated with the Web site. In other words, users may enter search queries 402 within any active Web page on the Web site, without being restricted to a designated search query entry area.

The technology presents a dynamic list of search result icons 404 that can be updated with each new character added to the search query. Alternatively, the technology can monitor time durations between data entry operations and can update the search result icons 404 after passage of a predetermined amount of time between data entry operations. The dynamically generated list provides users with low-latency feedback of context associated with the search query.

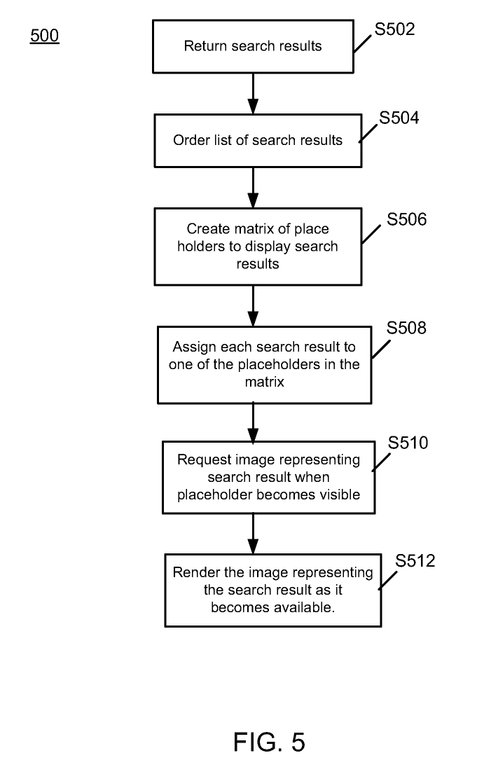

FIG. 5 illustrates an exemplary method 500 for returning a plurality of search results in step S502. The system 100 enables users to view additional search result icons 404 by scrolling through a screen of displayed search result icons 404. The search result icons 404 can be presented in a selected order in step S504. The process of displaying multiple screens of search result icons 404 is referred to as infinite scrolling.

In order to describe inefficiencies associated with conventional content scrolling, each Web page of search result icons 404 may be viewed as a single sheet of paper. Scrolling through a Web page of search result icons 404 typically causes the system 100 to render a new Web page of search result icons 404. Conventional methods of rendering multiple Web pages of search result icons 404 are inefficient for Web browsers.

By contrast, the system 100 can provide placeholders for the search result icons 404 in step S506 and can assign the search result icons 404 to a corresponding placeholder in step S508. The system 100 can request the icon content when the placeholder becomes visible on the GUI in step S510. The system 100 can render and populate the icon content in step S512 upon receipt. The placeholders can maintain a rank order until the search result icons 404 are populated. The rank order can be established based on selected categories, including a trending category or a user recommendation category, among other categories. The system 100 can arrange each Web page of the search result icons 404 as a grid. Additionally or alternatively, the rank order can be established based on selected signals, including relevant advertising and geography, among other selected signals.

Since content can be derived from a wide variety of sources, a variety of content can be indexed and made available for presentation to users. Rather than limit the content choices displayed to users, the system 100 can display content choices to users through the infinite scrolling feature described above. Content choices that are determined to match a user's search or menu selection can be displayed if the user scrolls to the render position on the result list. FIG. 5 illustrates an exemplary method embodiment for creating and displaying the infinite scrolling user interface.

The technology can generate and display a single search result icon or record that may represent multiple related versions of the online content. For example, the single record corresponding to the JDM Racers icon illustrated in FIG. 2 can be selected to present a plurality of episodes illustrated in FIG. 3. If multiple sources offer the substantially similar online content, then the corresponding episode can identify the multiple sources in a designated field, such as the “play at” field. FIG. 3 illustrates that the various episodes of JDM Racers can be accessed at the crunchy roll content source. In other words, the technology can present a plurality of video sources in a single record of a single Web browser application 109, regardless of how many online sources originate the online content.

The technology can implement a protocol to determine how to play online program content, e.g., an episode, presented in a selected record within the Web browser application 109. If a source of the online content is known, then the Web browser application 109 can access a player API having pre-configured properties, such as a larger screen size or other pre-configured property, and can reconfigure the online content for presentation on the player API. In this first example, the player API can automatically present the online program content without further user interaction. If a source of the online content indicates a particular format, such as an mp4 file having an HTML5 video tag, then the HTML5 compliant Web browser application can use a native player to configure the online content for presentation on the native player. In this example, the native player can automatically present the online content without further user interaction. Regarding this implementation, a browser cache can be configured to locally store data using a markup language, including Hyper Text Markup Language 5 (HTML5), among other markup languages. HTML5 allows Web sites to directly embed media with HTML tags, such as “<video>” and “<audio>” tags. In other words, HTML5 includes a native player that plays the HTML tags without using plug-ins.

If a source of the online content indicates a Flash player format, then the Web browser application 109 can use a pre-selected Flash player to configure the online content for presentation on the pre-selected Flash player. In this, the pre-selected Flash player can present the online content without further user interaction. If a source of the online program content is third-party, then the Web browser application 109 can enable a third party player to present the online content on the third party player. In this example, the Web browser application 109 has limited control over how the online content is presented, e.g., if the third party source offers an API to tailor presentation, then the present technology can take advantage of that API. The decision on how to play online content presented in a selected record within the Web browser application 109 can be controlled on one or both of the client side or the server side. According to some embodiments, the Web browser application 109 can access a library having HTML5 data and/or use a worker thread to render the decision.

The technology can respond to user action within the Web browser application 109 based on a context of the current activity. For example, if a user is performing data entry operations, such as character entry, the system 100 can determine whether to operate in a search mode or a log-in mode. If the user is performing navigation operations, such as scrolling among icons and navigating between levels, the system 100 can operate in a navigation mode. The data entry operations can be performed using data entry devices, including a keyboard, a mouse, a remote control, and a voice recognition system, among other data entry devices. The navigation operations can be performed using navigation devices, including a keyboard, a mouse, a remote control, a voice recognition system, and a motion detection system, among other navigation devices.

The system 100 can respond to user interaction based on the current activity context. For example, if a user is typing a search query or entering log-in credentials, then depressing the backspace key operates to delete a character. Alternatively, if a user is operating in a navigation mode, such as scrolling among icons and navigating within the Web browser application 109, then depressing the backspace key operates to cause the Web page to navigate between levels stages of the navigation history within the application.

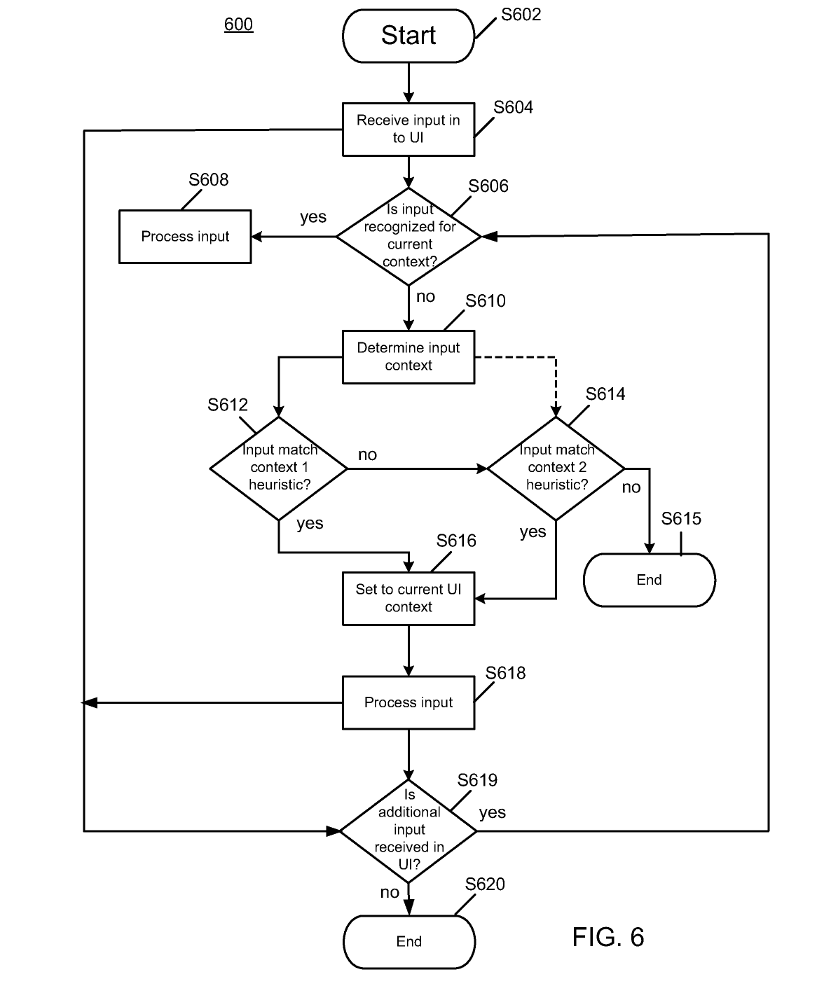

FIG. 6 illustrates an exemplary method 600 of determining current activity context. The method begins with step S602. In the example interfaces of FIG. 2 through FIG. 4, the UI context can recognize one of a navigational context or a search mode context because the log-in screen is not displayed. In step S604, an input can be received in the active UI. If the input is recognized in step S606 to be in one of the current context, then the system 100 processes the input in step S608 and proceeds to step S619. Otherwise, if the input is not recognized in step S606, then the method proceeds to step S610 to determine an input context. The received input is compared against a context 1 heuristic in step S612. If a match is found to exist, then the current UI is set to context 1 in step S616 and the system 100 processes the input in step S618 and proceeds to step S619. If a match is not found to exist in step S612, then the received input is compared against a context 2 heuristic in step S614. If a match is found to exist, then the current UI is set to context 2 in step S616 and the system 100 processes the input in step S618 and proceeds to step S619. Otherwise, if a match is not found to exist, then the process ends at step S615. In step S619, a determination is made regarding whether an additional input is received in the UI. If additional input is received, then the system 100 proceeds to step S606 and the method continues as discussed above. Otherwise, if additional input is not received, then the process ends at step S620. The dotted line in FIG. 6 represents that system 100 is capable to performing parallel processing operations.

In some embodiments, context 1 can include an authentication or log-in mode context. The authentication or log-in context can be activated when the user navigates to an authentication or log-in screen. The authentication or log-in context can be activated upon a user selecting a text field for entering user credentials. The context 2 can include a search mode context. If alphanumeric characters are input without the cursor first being placed in any specific field designated to accept text content, then the search mode context can be determined to be context 2.

As an illustration of the heuristics described above, the UI executing in the Web browser application 109 can be divided into groups of commons items: e.g. the left navigation pane, header items, list items, option items, etc. When a user is navigating the interface using arrows, the technology can keep track of whether context should be shifted from one group to the other. For example, if the user is currently interfacing in the left navigation area, and the technology receives input at the right arrow, the user interface can present the list group in certain cases, such as the home view. If the user is interfacing with the technology in the category view, the technology will present the category options group. These kinds of decisions can be made each time a navigation input is received at the Web application browser. Which context the user in interacting with the interface in can determines how each keystroke and navigation input is interpreted.

For example, receiving <enter> will prompt different responses depending on which con text the UI is in. If the user is currently interacting with the technology the navigation group, the technology can present a view corresponding to that context, i.e., categories, television, web movies, etc. If UI is presenting an episode list view and an episode images is selected, the technology will play the video.

When the Web browser application 109 receives non-navigation characters, e.g., alphanumeric, punctuation, etc., the technology can determine whether it should search based on the non-navigation characters. In the context of most groups, e.g., episodes, it can initiate a search. In the context of an input box, like the login form, the keystrokes will be rendered as characters in the input box.

When the Web browser application 109 receives typing input, the technology can check at predetermined periods, preferably every 500 ms, to determine if typing input continues. If so, the technology does not initiate a search. If the technology detects a pause more than this predetermined threshold, then it can send the search request. If the technology receives continued text input, it can restart the periodic check and continue searching.

If the technology receives <backspace> as an input, one of several things can happen. If the UI is in navigation mode, e.g., the user is providing input to moving around the UI, the technology can take the UI one step back in the application history. For example, if the UI starts in the home view and receives selection of a show or episode, the UI will present the episode interface, then receiving <backspace> as an input, the UI will return to the home view. As a further example, if the technology is accepting characters in search mode and the technology receives <backspace> as an input, it will delete characters from the search and check every predetermined period, e.g., 500 ms, as before to execute a search. If all the characters in a search are deleted, the technology can be taken out of typing/search mode and put back into navigation mode—where the rules of the navigation mode are applied.

The technology enables icon navigation through the Web browser application 109 using keys or buttons, among other navigation entry devices. According to some embodiments, a navigation application can be used to navigate the Web browser application 109 using navigation signals received from a navigation input device. The navigation input device can include keyboard or remote control device having an up arrow key, a down arrow key, a left arrow key and a right arrow key. The keys or buttons can generate commands that navigate a selection indicator over selectable icons provided in the Web browser application 109. According to some embodiments, the technology can facilitate icon navigation in a Web browser application 109 using remote control commands or motion commands. The technology also can enable icon navigation in the Web browser application 109 using interfaces such as a mouse, a track pad, a touch-sensitive screen, remote control, motion-sensing cameras (such as KINECT® by Microsoft®), motion sensitive devices (such as the Wii® joystick by Nintendo® and gyroscopes and accelerometers in mobile phone devices, etc.).

As addressed above, the user interface can be configured for rendering and execution in a Web browser application 109 so that the user interface can be displayed on many different platforms and devices. Some devices running the Web browser application 109 may not support one or more of the interfaces listed above for controlling the Web browser application 109. In such instances, a browser plug-in or other application or applet can be used to forward input received by the computer to the Web browser application 109. One of ordinary skill in the art will readily recognize that various remote functions or buttons may be used to navigate the graphical user interface.

According to one embodiment, the servers 115 can communicate with the Web browser application 109 to store a content state. Storing the content state enables the technology to navigate away from a Web site and return to the same content on the Web site during a next visit. The technology may provide content state storage both when navigating within the Web browser application 109 and when navigation outside of a Web browser application 109.

According to one embodiment, the technology may preserve content state information by extracting state information from content displayed on the browser application. The state information can include Uniform Resource Locator (URL) links, inputted search queries, navigation level information within the Web browser application 109, timing data associated with viewed or retrieved content, content source filter information, and playlist queue information, among other state information. The content state information can be preserved primarily in a client-side storage structure using a local store API, among other features. The local store API can be called to re-populate the Web browser application 109 when the application returns to the same spot in the application. In other words, the technology can store current state information. When users leave the application to view content provided on third party Web sites, the technology can re-populate the browser application with prior state information upon return to the browser application. As a result, the user can be returned and can view a same graphical user interface as previously viewed in the target Website.

The local store API can store bookmark Web page state information and sub-state information to improve browser performance. Performance may improve through increased access speed, among providing other improvements. The browser cache can be employed to store log-in credentials so that users can return to prior in-session environments. Additionally, some application state information can be stored in server-side storage structures, e.g., to facilitate user migration among different media devices 102. One of ordinary skill in the art will readily appreciate that other techniques can be employed to store the content data on client-side and server-side storage structures. For example, the state information can be preserved by adding items to a universal queue as discussed below.

In addition to preserving the state of browser application graphical user interface, the technology can preserve the state of multimedia content. In other words, users may migrate away from playing multimedia content and may resume playback of the content at a same spot in the content when the migration occurred. To this end, the technology can obtain multimedia content playback states and can control a playback of multimedia content through the use of APIs. The technology can request multimedia content playback status indicators, including a time indicators, a chapter indicator or a subchapter indicator, among other playback status indicators. The technology can store the playback status indicators in a same manner discussed above. For example, users may return to the multimedia content source and may select to resume playback of the same multimedia content. The technology can provide users with playback status indicators via the APIs that enable playback of the multimedia content from the spot the user left off

To the extent that third party content sources do not support APIs for this purpose, the technology can use alternate techniques for preserving the state of the multimedia content. According to some embodiments, the technology can transcribe text within the multimedia content upon receiving a command to navigate away from the multimedia content. The technology can apply text recognition to extract playback duration from database 140, which includes a preestablished text listing corresponding to the multimedia content. Alternatively, the technology can employ real-time text recognition to determine a location within the multimedia content to resume playback.

According to some embodiments, the technology can record a position of a status indicator icon associated with the media player, such as a slider on a playback status indicator. Upon returning to the media player to resume viewing the multimedia content, the technology can re quest the media player to begin playback from the spot corresponding to the position of the status indicator icon where the user left off. If the content source does not accept such a request, the technology can navigate the playback slider to its previous position (or a position slightly earlier), as determined by the recorded position of the slider or the playback duration indicated on the displayed Webpage or media player.

The content available for playback can be derived from any number of different sources. The sources can be Internet sources, local network sources (such as DVR), and non-networked sources such as DVDs, Blu-Ray discs, etc. Each item of content may be indexed and can be made available to the user through the technology. For example, the technology can employ a worker thread to index offline content. The worker thread can operate in a background to per form offline content indexing and similar tasks that would otherwise contribute to latency. Alternatively, the technology can perform offline indexing on servers. Furthermore, the technology can use an API to create an index of offline content, which may be cached locally.

According to some embodiments, the technology enables users to create content playlists, called a universal queue. The universal queue provides a list of content that users desire to consume, regardless of source. For example, some content in a user's universal queue can originate from the user's personal content collection, such as DVD's. Additionally, some content in a user's universal queue can originate from free online sources. Still further, some content in a user's universal queue can originate from a paid subscription service or a rental service, live television, and local storage.

An item listed in the universal queue can correspond to a URL for content provided on the Internet. The Internet content can include movies, shows or episodes, among other content, which can be catalogued in the database 140. Offline content listed in the universal queue can be identified as offline content. The system 100 can retrieve indexed offline content upon selection of the data item corresponding to the indexed offline content. Also, the system 100 can be configured to take no further action for offline content that is not indexed.

The system 100 can reorder the universal queue list to provide users with more options. For example, the system 100 can reorder the universal queue list based on recommendations from friends or due to date related events, such as expiration of a URL. The system 100 can reorder the universal queue in response to selected filter options, or updates to a personal profile. The universal queue can be subject to reordering based on public collaboration. Still further, the universal queue can be a semi-dynamic list that enables users to make selections, while also allowing the system to add more items based on the user selections. For example, comments related to certain content that is trending upwards as a conversation topic can be predicatively added to the universal queue or moved up in the universal queue.

In some embodiments, the technology can accept suggestions from other users for adding content to a user's universal queue. Further still, the technology can enable two or more users to schedule a viewing of a program, so that the users can watch the content at the same time, but in different locations. In such instances, the universal queue also can perform scheduler functions.

In some instances, a user will not have the capability to access all of the content indexed by the technology. For example some content will only be available to subscribers of a particular service or content provider. In such instances the technology can be configured to exclude content only available from those content sources which the user designates.

In some embodiments, the technology is a video content delivery client computer program product for operation with a video content delivery server. The computer program product includes a Web browser application 109. The Web browser application 109 includes a user interface module 110 operative upon execution by a data processing system to interface with a user for receiving and processing user inputs, and for presenting content, information, and controls. The Web browser application 109 also includes a server interface module 111 operative upon execution by the data processing system to send data to, and retrieve data from, a server asynchronously from operation of the user interface module 110.

In further embodiments, the Web browser application is an HTML5 Web browser application. In some embodiments, the Web browser application 109 includes a client data store operative for asynchronous exchange of data between the user interface module 110 and the server interface module 111. In some embodiments the user interface module 110 is further operative to record a state of the Web browser application 109 prior to a change in Web browser application state and return the Web browser application 109 to the recorded state upon input from a user. In some embodiments, the user interface module 110 embodies UI contexts. The UI contexts accept at least one common user action as an input and operate to predict the context of an accepted common action through use of at least one heuristic.

The technology can be implemented using hardware or software in association with hardware. In some embodiments, the software can include firmware or resident software, among other software. The technology can take the form of a computer program product that includes program modules accessible from computer-usable or computer-readable medium storing program code for use by or in connection with one or more computers, processors, or instruction execution system.

For the purposes of this description, a computer-usable or computer readable medium can be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code may be used for implementing aspects of the technology, which can be centralized or distributed (or a combination thereof) as known to those skilled in the art.

A data processing system suitable for storing a computer program product of the technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to be come coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. The scope of the invention is defined by the appended claims.

We claim:

1. A video content delivery method operating in a network environment to display online content on a media device through a Web browser having an application program interface, the online content being received at a server from a plurality of content sources, the video content delivery method comprising:
receiving an online content request at the server;
transmitting the requested online content to the Web browser;
providing instructions to store the online content in the application program interface associated with the Web browser;
rendering the online content from the application program interface to the Web browser graphical user interface;
updating the online content between the server and the Web browser asynchronously while rendering of the online content; and
providing instructions to store state information from the graphical user interface to the application program interface.

2. The video content delivery method according to claim 1, wherein:
rendering the online content from the application program interface to the Web browser graphical user interface is performed simultaneously with updating the online content between the server and the Web browser.

3. The video content delivery method according to claim 1, further comprising dynamically pulling online content from the application program interface to the Web browser graphical user interface.

4. The video content delivery method according to claim 1, further comprising:
enabling the Web browser to perform tasks including at least one of data validation, data manipulation and display rendering.

5. The video content delivery method according to claim 1, wherein:
receiving the online content request includes receiving at least one of a content selection request, a content delivery option request, and a content resolution request.

6. The video content delivery method according to claim 1, wherein:
receiving the online content request includes receiving instructions from the media device based on results from executing a search query.

7. The video content delivery method according to claim 6, wherein:
receiving the online content request includes receiving instructions from the media device to provide a dynamic list of search results that is updated with entry of characters in the search query.

8. A video content delivery method operating in a network environment to display online content on a media device through a Web browser having an application program interface, the online content being received at a server from a plurality of content sources, the video content delivery method comprising:
receiving an online content request at the server;
transmitting the requested online content to the Web browser;
providing instructions to store the online content in the application program interface associated with the Web browser;
associating an icon with selected online content;
providing a placeholder for the icon;
rendering the online content for the corresponding icon from the application program interface to the Web browser when the icon enters an active region of a graphical user interface; and
updating the online content between the server and the Web browser asynchronously while rendering of the online content.

9. The video content delivery method according to claim 8, wherein:
rendering the online content from the application program interface to the Web browser when the icon enters the active region of the graphical user interface is performed simultaneously with updating the online content between the server and the Web browser.

10. The video content delivery method according to claim 8, further comprising:
dynamically pulling online content from the application program interface to the Web browser when the icon enters the active region of the graphical user interface.

11. The video content delivery method according to claim 8, further comprising:
enabling the Web browser to perform tasks including at least one of data validation, data manipulation and display rendering.

12. The video content delivery method according to claim 8, wherein:
receiving the online content request includes receiving at least one of a content selection request, a content delivery option request, and a content resolution request.

13. The video content delivery method according to claim 8, wherein:
receiving the online content request includes receiving instructions from the media device based on results from executing a search query.

14. The video content delivery method according to claim 13, wherein:
receiving the online content request includes receiving instructions from the media device to provide a dynamic list of search results that is updated with entry of characters in the search query.

15. A video content delivery method operating in a network environment to display online content on a media device through a Web browser having an application program interface, the online content being received at a server from a plurality of content sources, the video content delivery method comprising:
receiving an online request at the server;
determining an operation context from the received online request;
enabling one of a search mode, a log-in mode or a navigation mode based on the determined operation context from the online request;
performing one of a character entry function or a navigation function on a graphical user interface; and
updating the online content between the server and the Web browser asynchronously while rendering of the online content.

16. The video content delivery method according to claim 15, further comprising:
dynamically pulling online content from the application program interface to the Web browser when performing the navigation function.

17. The video content delivery method according to claim 15, further comprising:
enabling the Web browser to perform tasks including at least one of data validation, data manipulation and display rendering.

18. The video content delivery method according to claim 15, wherein receiving:
the online request includes receiving at least one of a content selection request, a content delivery option request, and a content resolution request.

19. The video content delivery method according to claim 15, wherein:
receiving the online request includes receiving instructions from the media device based on results from executing a search query.

20. The video content delivery method according to claim 19, wherein:
receiving the online content request includes receiving instructions from the media device to provide a dynamic list of search results that is updated with entry of characters in the search query.

21. A video content delivery method operating in a network environment to display online content on a media device through a Web browser having an application program interface, the online content being received at a server from a plurality of content sources, the video content delivery method comprising:
receiving an online content request at the server;
transmitting the requested online content to the Web browser;
providing instructions to store the online content in the application program interface associated with the Web browser;
associating an icon with selected online content;
providing a placeholder for the icon;
rendering the online content for the corresponding icon from the application program interface to the Web browser when the icon enters an active region of a graphical user interface;
updating the online content between the server and the Web browser asynchronously while rendering of the online content; and
enabling navigation of the icon upon receiving navigation signals from navigation entry devices.

22. The video content delivery method according to claim 21, wherein:
rendering the online content from the application program interface to the Web browser is performed simultaneously with updating the online content between the server and the Web browser.

23. The video content delivery method according to claim 21, further comprising:
dynamically pulling online content from the application program interface to the Web browser.

24. The video content delivery method according to claim 21, further comprising:
enabling the Web browser to perform tasks including at least one of data validation, data manipulation and display rendering.

25. The video content delivery method according to claim 21, wherein:
receiving the online content request includes receiving at least one of a content selection request, a content delivery option request, and a content resolution request.

26. The video content delivery method according to claim 21, wherein:
receiving the online content request includes receiving instructions from the media device based on results from executing a search query.

27. The video content delivery method according to claim 26, wherein:
receiving the online content request includes receiving instructions from the media device to provide a dynamic list of search results that is updated with entry of characters in the search query.

28. A video content delivery client computer program product for operation with a video content delivery server, the computer program product comprising:
a tangible computer readable medium; and
a Web browser application;
the Web browser application:
residing on the medium; and
comprising:
a user interface module operative upon execution by a data processing system to interface with a user for receiving and processing user inputs, and for presenting content, information, and controls; and
a server interface module operative upon execution by the data processing system to send data to, and retrieve data from, a server asynchronously from operation of the user interface module.

29. The computer program product of claim 28, the Web browser application comprising an HTML5 Web browser application.

30. The computer program product of claim 28, the Web browser application further comprising a client data store operative for asynchronous exchange of data between the user interface module and the server interface module.

31. The computer program product of claim 28, the user interface module further operative to record a state of the Web browser application prior to a change in Web browser application state and return the Web browser application to the recorded state upon input from a user.

32. The computer program product of claim 28, the user interface module:
having a plurality of contexts, the contexts accepting at least one common user action as an input; and
operative to predict the context of an accepted common action through application of at least one heuristic.

33. A video content delivery client system for operation with a video content server, the system comprising:
at least one processor:
a video content delivery client computer program product comprising:
a tangible computer readable medium; and
a Web browser application;
the Web browser application:
residing on the medium; and
comprising:
a user interface module operative upon execution by a data processing system to interface with a user for receiving and processing user inputs, and for presenting content, information, and controls; and
a server interface module operative upon execution by the data processing system to send data to, and retrieve data from, a server asynchronously from operation of the user interface module.

34. The computer program product of claim 33, the Web browser application comprising an HTML5 Web browser application.

35. The computer program product of claim 33, the Web browser application further comprising a client data store operative for asynchronous exchange of data between the user interface module and the server interface module.

36. The computer program product of claim 33, the user interface module further operative to record a state of the Web browser application prior to a change in Web browser application state and return the Web browser application to the recorded state upon input from a user.

37. The computer program product of claim 33, the user interface module:
having a plurality of contexts, the contexts accepting at least one common user action as an input; and
operative to predict the context of an accepted common action through application of at least one heuristic.
